(19) United States
(12) Patent Application Publication
(10) Pub. No.: US 2008/0028086 A1
(43) Pub. Date: Jan. 31, 2008

(54) Method and Apparatus for Preserving Isolation of Web Applications when Executing Fragmented Requests

(76) Inventors: Madhu K. Chetuparambil, Raleigh, NC (US); Srinivas Hasti, Raleigh, NC (US); Stephan Hesmer, Gaertringen (DE); Todd E. Kaplinger, Raleigh, NC (US); Subbarao Meduri, Cary, NC (US); Maxim A. Moldenhauer, Durham, NC (US); Aravind Srinivasan, Raleigh, NC (US)

Correspondence Address: IBM CORP. (RALEIGH SOFTWARE GROUP);c/o Rudolf O Siegesmund Gordon & Rees, LLP, 2100 Ross Avenue, Suite 2800, DALLAS, TX, 75201, US

(21) Appl. No.: 11/460,443

(22) Filed: Jul. 27, 2006

(51) Int. Cl. G06F 15/16

(52) U.S. Cl. 709/230; 709/219

(57) ABSTRACT

A Fragment Aggregator utilizes an application independent surrogate to dispatch fragments and receive responses between isolated web applications. Clients send web application requests to the surrogate, which forwards the request to an isolated web application. When a web application requires other isolated web applications to execute the request, the web application responds to the request with a deferred response. The deferred response includes request fragments for the other isolated web applications. The Fragment Aggregator dispatches the fragments to the other isolated web applications. After receiving responses from the isolated web applications, the Fragment Aggregator combines the response and sends them to the client.

### FIELD OF THE INVENTION

The invention relates generally to computer data processing, and particularly to preserving isolation of web applications when executing fragmented requests.

### BACKGROUND OF THE INVENTION

The Internet allows a user to display text and graphics on a web page at the user's local computer, and also to perform tasks using web applications on remote computers. The web applications that can be run on remote computers include programs that can calculate income taxes, research and trade stocks, and conduct bank transactions. Users include employees who perform work-related computer tasks on remote servers that contain all of the user's desktop applications and that are accessed through Internet. In other words, the actual computer running the employee's desktop applications may be in another city, state, or country.

Typically, a “computer” hosts the remotely accessed web applications in a distributed computer environment comprising a collection of servers where each of the servers are controlled by the same management software. Although remotely accessed web applications may run on the same distributed computer environment, the remotely accessed web applications may be physically or logically isolated on separate servers or partitions. Usually, developers create physical or logical isolation of remotely accessed web applications because different web applications require different operating systems or physical resources, or because different organizations deploying web applications on a common host require isolation for business or security reasons. When web applications are isolated from each other, direct communication between the isolated web applications is prohibited.

Distributed computer environments permit remote users of web applications, hereafter referred to as “clients,” not only to access remote web applications but also to perform tasks on multiple web applications. In order to perform a typical task on a remote web application, a client sends a request from a client computer to the remote web application on a first remote server, and the client receives a response to the request from the remote web application on the first remote server. Often, the request requires accessing a second web application in order to execute the request. When a request requires access to a second web application, a program at the first remote server breaks the request into a series of fragments and sends each fragment to a server having the appropriate first or second web application for executing the fragment and for generating a response to the fragment. The server and web application receiving the fragment executes the fragment to generate a fragment response, and returns the fragment response to the first remote server. The first remote server receives the fragment response and responses to other fragments of the request, and reassembles the fragment responses into a complete response. Programs handling the process of breaking a request into fragments, sending the fragments to the appropriate server and application, and aggregating the results are known as fragment markup and assembly engines. Several fragment markup and assembly technologies are known in the art, such as EDGE SIDE INCLUDE (ESI), and DELTA ENCODING.

Fragment markup and assembly engines encounter two problems. The first problem arises when the fragments must be executed in a specific sequence. Fragments must be executed in a specific sequence when the execution of one fragment generates a response containing an argument or “context” necessary to execute a subsequent fragment. Failure to execute fragments in the proper sequence results in an incomplete or incorrect response to the initial request. The second problem arises when two or more request fragments require execution on a first web application and a second web application, where the first and second web applications must be isolated from each other. When the server or partition with the first web application attempts to communicate by forwarding a fragment and any associated context to the second web application, the fragment transmission will either fail or violate the security policy, because communication between the isolated first and second web applications is prohibited.

The first problem discussed above involving sequence of fragment execution is addressed in U.S. patent application Ser. No. 11/386,610 (the '610 application). The '610 application discloses a method and apparatus to ensure fragments are executed in a specific sequence. The second problem discussed above involves request fragment execution on web applications that are required to be isolated from each other so that the isolated web applications cannot communicate directly to each other. If the isolated web applications cannot communicate directly with each other, the method and apparatus disclosed in the '610 application may not be able to execute the request fragments properly. Furthermore, allowing the isolated web applications to communicate directly with each other may violate contractual or security policies.

Therefore, a need exists for an improved fragment markup and assembly engine that can dispatch fragments to isolated web applications, execute the request fragments in the proper sequence, make required context from an executed request fragment available for subsequently executed fragments dependent on the context, and aggregate the responses without violating logical or physical isolation requirements for the applications.

### SUMMARY OF THE INVENTION

A “Fragment Aggregator Program” utilizes an application independent surrogate computer to dispatch fragments and to receive responses from isolated web applications so that the isolated web applications do not have to communicate directly with each other while executing fragment requests. The Fragment Aggregator comprises a fragment dispatcher program and an application helper program. The fragment dispatcher program runs on a surrogate computer coupled to and in communication with a client computer and a distributed computer environment with isolated web applications. The application helper program runs on each server hosting web applications in the distributed computer environment. When a client computer sends a request to a web application, the fragment dispatcher program adds metadata to the request to indicate that the request is a new request, and then forwards the request fragment to the appropriate isolated web application. If the isolated web application needs to access other isolated web applications to complete execution of the request, the request is broken down into fragments by a fragment markup and assembly engine. The application helper program at the application server adds metadata to each of the fragments and sends each of the request fragments back to the fragment dispatcher program on the surrogate computer as a “deferred response.” The fragment dispatcher program at the surrogate computer dispatches each fragment in sequence, receives the responses for each fragment, and saves the responses in a cache. Fragments are dispatched to the appropriate web applications with metadata containing any required context updates received from previous fragment responses. The application helper program, at the server containing the appropriate web application, interprets the fragment's metadata to ensure that the web application receives the context updates, and sends the fragment response back to the surrogate computer. The fragment dispatcher program at the surrogate computer aggregates all the cached fragment responses, and sends an aggregated response to the client. By dispatching request fragments to isolated web applications from a surrogate, the fragment aggregator program removes the requirement for direct communication between isolated web applications, and preserves the isolation between each of the isolated web application.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 depicts an exemplary computer network;

FIG. 2 depicts an exemplary memory on a computer containing the Fragment Aggregator;

FIG. 3 depicts a flowchart of a Fragmented Dispatcher;

FIG. 4 depicts a flowchart of an Application Helper;

FIG. 5 depicts a diagram of a fragmented request being dispatched to isolated web applications using the prior art; and

FIG. 6 depicts a diagram of a fragmented request being dispatched to isolated web applications using a surrogate and the fragment aggregator.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory. The term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “Fragment Aggregator.”

Additionally, the Fragment Aggregator is described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 105, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

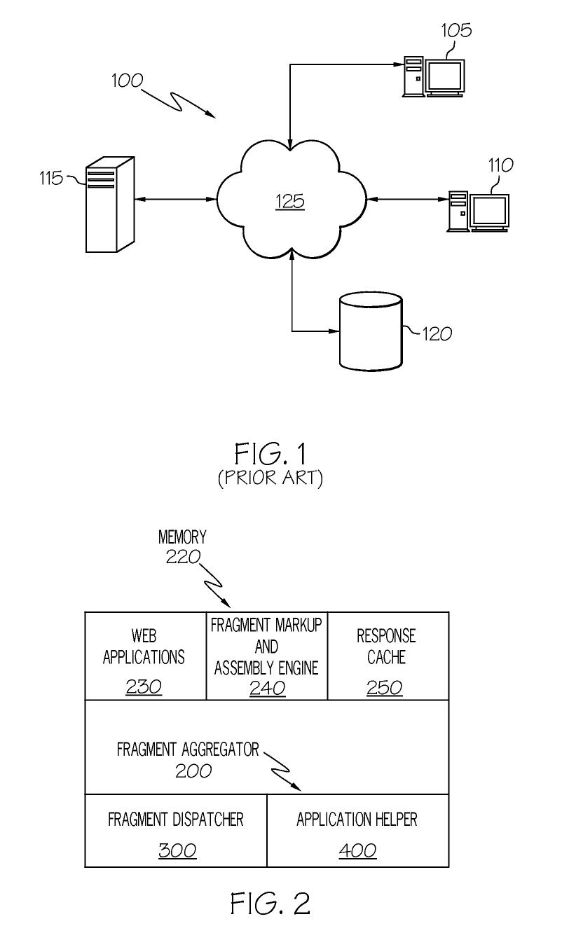

Fragment Aggregator 200 typically is stored in a memory, represented schematically as memory 220 in FIG. 2. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Further, Fragment Aggregator 200 may reside in more than one memory distributed across different computers, servers, logical partitions or other hardware devices. The elements depicted in memory 220 may be located in or distributed across separate memories in any combination, and Fragment Aggregator 200 may be adapted to identify, locate and access any of the elements and coordinate actions, if any, by the distributed elements. Thus, FIG. 2 is included merely as a descriptive expedient and does not necessarily reflect any particular physical embodiment of memory 220. As depicted in FIG. 2, though, memory 220 may include additional data and programs. Of particular import to Fragment Aggregator 200, memory 220 may include Web Applications 230, Fragment Markup and Assembly Engine 240, and Response Cache 250 with which Fragment Aggregator 200 interacts. Web Applications 230 perform tasks by responding to requests. Fragment Markup and Assembly Engine 240 fragments requests intended for Web Applications 230. Fragment Markup and Assembly Engine 240 may be an ESI engine. Response Cache 250 is a temporary storage for responses to dispatched fragments. Fragment Aggregator 200 has two components: Fragment Dispatcher 300 and Application Helper 400. The Fragment Dispatcher 300 in this example operates on a surrogate computer responsible for propagating requests to network 100. Application Helper 400 operates on a web application server in conjunction with Fragment Markup and Assembly Engine 240 and Web Applications 230.

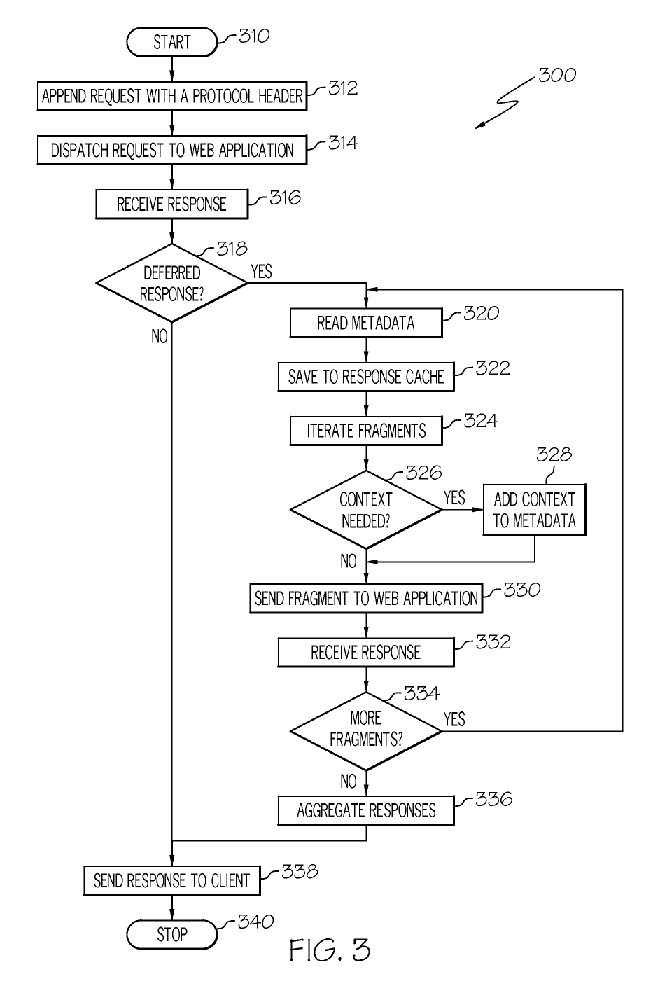

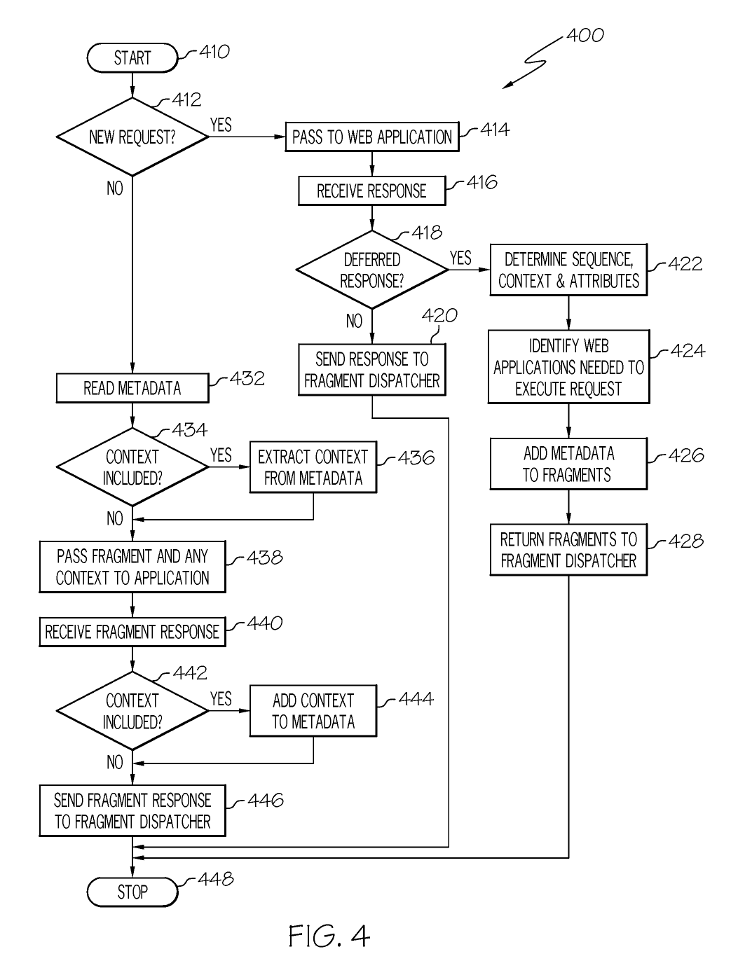

FIG. 3 is a flowchart depicting the logic of Fragment Dispatcher 300. Fragment Dispatcher 300 starts when an initial request is made by a client (310). Fragment Dispatcher 300 appends the initial request with a metadata protocol header (312). The protocol header initializes the context propagation. Fragment Dispatcher 300 dispatches the initial request to web applications 230 (314). Fragment Dispatcher 300 receives a response to the initial request (316), and determines if web applications 230 made a normal response or a deferred response (318). A normal response is sent to the client (338) and Fragment Dispatcher 300 ends (340). A deferred response occurs when web applications 230 require other isolated web applications to execute the request. Fragment Markup and Assembly Engine 240 splits the initial request into a sequence of fragments to be run on other isolated web applications 230. Application Helper 400 appends each fragment with metadata protocol headers identifying which web application should run the fragment (see FIG. 4). Additional metadata provided by Application Helper 400 specifies sequence information and whether each fragment requires specific attributes or contexts in order to execute properly. An attribute sent as a response to a fragment can be appended as a context when dispatching a subsequent fragment. In the case of a deferred response, web applications 230 may execute one or more fragments as part of the response, such as setting an initial attribute.

If at step 318, a determination is made that a response is a deferred response, Fragment Dispatcher 300 reads the initial response information in each fragment's metadata protocol header (320) and saves the information to response cache 250 (322). Fragment Dispatcher 300 iterates through each fragment in sequence, using the sequencing and context information in the metadata protocol headers (324).

If an attribute or other context needs to be added to a fragment (326), Fragment Dispatcher 300 adds the context (328), which may have been saved in response cache 250, before dispatching the fragment to web applications 230 (330). In other words, Fragment Dispatcher 300 adds metadata referencing updates to context from previous fragment responses within the scope of the logical request. In addition to adding attributes and contexts, Fragment Dispatcher 300 may add other information to the metadata protocol header, such as terminating context propagation with the final fragment or including any delegated security credentials from the original client necessary to access an isolated web application. Fragment Dispatcher 300 receives the response from web applications 230 (332) and determines whether there are more fragments left to dispatch (334). If there are more fragments, Fragment Dispatcher 300 goes to step 320, and if not, (the final fragment has been dispatched) aggregates all the responses stored in response cache 250 (336), sends the combined response to the client (338), and stops (340).

FIG. 4 is a flowchart depicting the logic of Application Helper 400. Application Helper 400 starts whenever web application 230 receives a request or fragment from Fragment Dispatcher 300 (410). Application Helper 400 determines if it is a new request or a request fragment (412). New requests are passed to web applications 230 (414) and web applications 230 returns a response (416). Application Helper 400 determines if web applications 230 returned a full response or a deferred response (418). A deferred response occurs when web applications 230 require other isolated web applications to execute the request. Fragment Markup and Assembly Engine 240 splits the initial request into a sequence of fragments to be run on other isolated web applications 230. If web applications 230 returns a full response, Application Helper 400 sends the response to Fragment Dispatcher 300 (420) and stops (448). If web applications 230 returns a deferred response, Application Helper 400 determines the sequence for running the fragments if necessary, and any context or attributes required to execute each fragment (422). Application Helper 400 identifies which isolated web applications 230 will run each fragment (424). Application Helper 400 adds metadata containing all the sequence, context, attribute and web application information to the fragments (426), returns the fragments to Fragment Dispatcher 300 (see FIG. 3) (428) and stops (448).

If at step 412, Application Helper 400 receives a dispatched fragment rather than a new request from Fragment Dispatcher 300, Application Helper 400 reads the metadata for the dispatched fragment (432), and determines whether context is included in the fragment (434). If context is included, Application Helper 400 extracts context from the metadata (436), and goes to step 438. If context is not included, Application Helper 400 goes to step 438 where it passes the fragment and any context to the application (438). Next, Application Helper 400 receives a fragment response from web application 230 (440) and determines whether context is included (442). If so, it adds context to the metadata (444) and goes to step 446. If context was not included, Application Helper 400 goes to step 446 where it sends a fragment response to Fragment Dispatcher 300 (446) and stops (448).

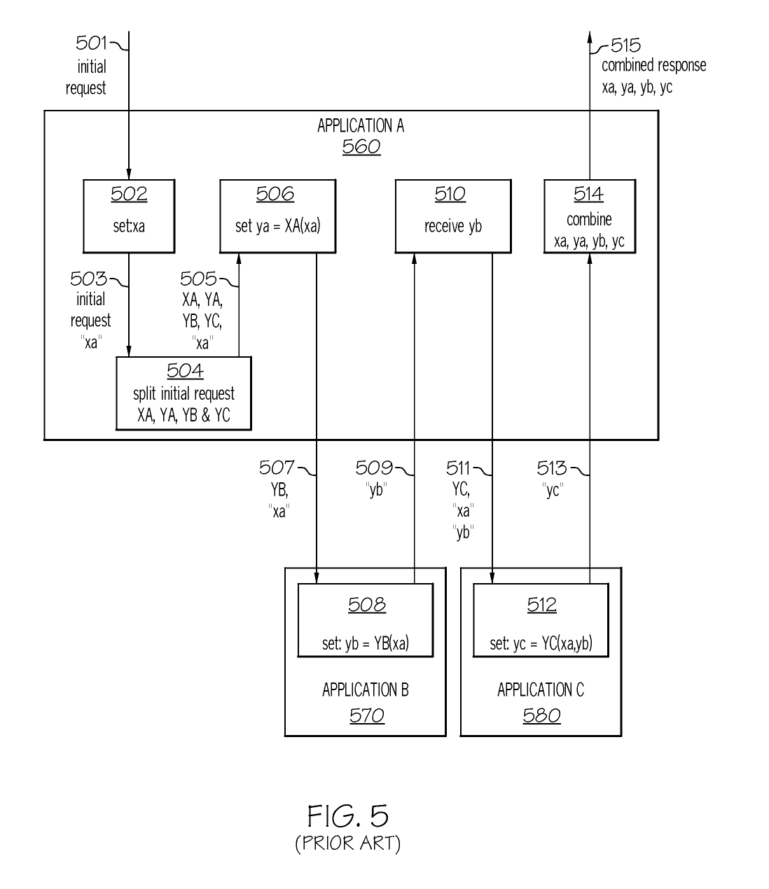

FIG. 5 depicts the prior art propagation of a fragmented request. In the prior art, Application A 560, Application B 570, and Application C 580 are physically and logically isolated from each other. In order to process a fragmented request from a client, each application must communicate with each other. This direct communication may violate the isolation rules in the application's programming. Numeral 501 represents an initial request made by a client. Numeral 502 represents web application A 560 setting an initial attribute “xa” in response to the client request, but determining that it needs content from web application B 570 and web application C 580 to fully execute the original client request. Numeral 503 represents web application A 560 communicating the need for content from other web applications with Fragment Markup and Assembly Engine 240. Fragment Markup and Assembly Engine 240 runs on the same application server as web application A 560. 505 represents Fragment Markup and Assembly Engine 240 splitting the initial request into four fragments (XA, YA, YB and YC) and sending the fragments back to Application A 560. Numeral 506 represents web application A 560 executing a response to fragment YA using the initial attribute “xa” associated with fragment XA.

Numeral 507 represents web application A 560 dispatching fragment YB with attribute “xa” to web application B 570. Numerical 508 represents web application B 507 setting attribute “yb” in response to fragment YB and attribute “xa.” Numeral 509 represents web application B 570 sending the response to fragment YB with attributes “yb” to web application A 560. Numeral 510 represents web application A 560 receiving the response. Numeral 511 represents web application A 560 dispatching fragment YC with attributes “xa” and “yb” to web application C 580. Numeral 512 represents web application C 580 performing required actions using attributes “xa” and “yb” in response to fragment YC. Numeral 513 represents web application C 580 sending the final response attribute “yc” to web application A 560. Numeral 514 represents web application A 560 receiving the response and aggregating the response with the previous responses. Numeral 515 represents web application A 560 sending the combined response “xa,” “ya,” “yb” and “yc” to the client.

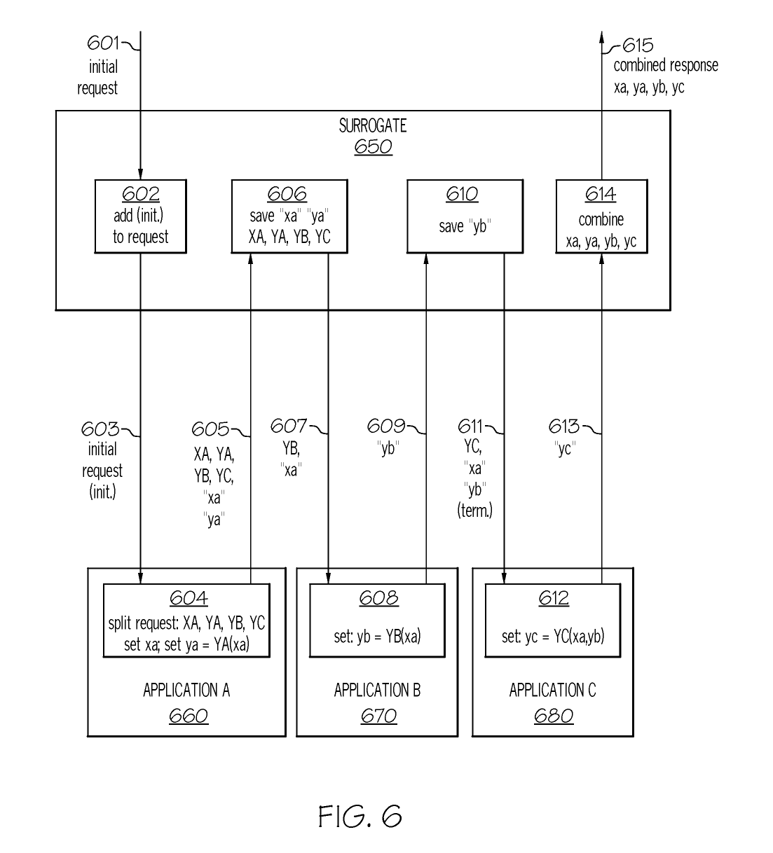

FIG. 6 depicts propagation of a fragmented request using the Fragment Aggregator. As in FIG. 5 above, Application A 660, Application B 670, and Application C 680 are physically and logically isolated from each other. Surrogate computer 650 dispatches a fragmented request from a client, and aggregates the responses from each application. Each isolated application only communicates with the surrogate, and not with each other. The indirect communication preserves the isolation rules in each application's programming. Numeral 601 represents an initial request made by a client. Numeral 602 represents a Fragment Dispatcher 300 running on Surrogate 650 that appends the initial request with a metadata protocol header to initialize the context propagation. Numeral 603 represents surrogate 650 dispatching the initial request to web application server A 660. At Numeral 604, Fragment Markup and Assembly Engine 240 on web application A 660 splits the initial request into four fragments (XA, YA, YB and YC). Sequencing information is added to the metadata protocol headers of each fragment. Web application A 660 sets an initial attribute “xa” then executes a response to fragment YA containing attribute “ya” using the initial attribute “xa.” Numeral 605 represents sending a deferred response containing the four request fragments and the attributes “xa” and “ya” back to Surrogate 650. Numeral 606 represents Surrogate 650 saving the attributes to response cache 250.

Numeral 607 represents Surrogate 650 dispatching fragment YB with attribute “xa” to application server 680. Numerical 608 represents web application B 670 setting attribute “yb” in response to the fragment YB and attribute “xa.” Numeral 609 represents web application B 670 sending the response with attribute “ya” to Surrogate 650. Numeral 610 represents Surrogate 650 receiving the response and saving the response to response cache 250. Numeral 611 represents Surrogate 650 dispatching fragment YC with attributes “xa” and “ya” to web application C 680. Fragment YC also contains metadata protocol header information to terminate context propagation. Numeral 612 represents web application C 680 performing required actions using attributes “xa” and “yb” in response to fragment YC. Numeral 613 represents web application C 680 sending the final response with attribute “yc” to Surrogate 650. Numeral 614 represents surrogate 650 receiving the response with attribute “yc” and aggregating the response with the previous responses in response cache 250. Numeral 615 represents surrogate 650 sending the combined response “xa,” “ya,” “yb” and “yc” to the client.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer implemented process for dispatching fragments of a request to isolated web applications, the computer implemented process comprising:
dispatching request fragments with a dispatcher program on a surrogate computer to at least two isolated web applications;
receiving request fragment responses at the dispatcher program on the surrogate computer from the at least two isolated web applications,
wherein each isolated web application runs on a separate server or partition and each isolated web application does not communicate directly with another isolated web application.

2. The computer implemented process of claim 1 further comprising:
receiving a request from a client computer at a surrogate computer in communication with isolated web applications on a distributed computer environment;
forwarding the request from the surrogate computer to an isolated web application;
receiving a deferred response at the surrogate computer from the isolated web application, wherein the deferred response includes more than one request fragment and wherein an application helper program added a metadata protocol header to each fragment indicating an isolated web application for executing the fragment;
dispatching each fragment from the surrogate computer to an isolated web application;
receiving responses from the isolated web application for each fragment at the surrogate computer;
combining the responses; and
sending the combined response from the surrogate computer to the client computer.

3. The computer implemented process of claim 2 further comprising storing responses from the isolated web application for each fragment in a cache on the surrogate computer.

4. The computer implemented process of claim 3, further comprising extracting a context for executing a fragment from the cached response of a previously executed fragment.

5. The computer implemented process of claim 4, further comprising adding a metadata protocol header to the fragment with the context before dispatching the fragment.

6. The computer implemented process of claim 1, further comprising dispatching the fragments in a particular sequence.

7. A computer program product for dispatching fragments of a request to isolated web applications, the computer program product comprising:
a first instruction to receive a request from a client computer at a surrogate computer in communication with isolated web applications on a distributed computer environment;
a second instruction to forward the request from the surrogate computer to an isolated web application;
a third instruction to receive a deferred response at the surrogate computer from the isolated web application, wherein the deferred response includes more than one request fragment and each fragment contains a metadata protocol header indicating an isolated web application for executing the fragment;
a fourth instruction to dispatch each fragment to the indicated isolated web application;
a fifth instruction to receive responses at the surrogate computer from the isolated web application for each fragment
a sixth instruction combine the responses; and
a seventh instruction to send the combined response from the surrogate computer to the client computer.

8. The computer program product of claim 7 further comprising an instruction to store responses from the isolated web application for each fragment in a cache on the surrogate computer.

9. The computer program product of claim 8, further comprising an instruction to extract a context for executing a fragment from the cached response of a previously executed fragment.

10. The computer program product of claim 9, further comprising an instruction to add a metadata protocol header to the fragment with the context before dispatching the fragment.

11. The computer program product of claim 7, further comprising an instruction to dispatch the fragments in a particular sequence.

12. An apparatus for dispatching fragments of a request to isolated web applications comprising:
a network connecting a plurality of computers, wherein the computers run physically and logically isolated web applications;
a surrogate computer connected to the network;
a memory on the surrogate computer containing a fragment aggregator program, the program directing the processor to: dispatch request fragments to at least two isolated web applications and receive request fragment responses from the at least two isolated web applications, wherein each isolated web application does not communicate directly with another isolated web application.

13. An apparatus for dispatching fragments of a request to isolated web applications comprising:
a network connecting a plurality of computers, wherein the computers run physically and logically isolated web applications;
a surrogate computer connected to the network and to a memory containing a program, the program directing the processor to:
receive a request from a client;
forward the request to an isolated web application;
receive a deferred response from the isolated web application, wherein the deferred response includes more than one request fragment and each fragment contains a metadata protocol header indicating isolated web application for executing the fragment;
dispatch each fragment to the indicated isolated web application;
receive responses from the isolated web application for each fragment;
combine the responses; and
send the combined response to the client.

14. The apparatus of claim 13 wherein the program further directs the surrogate computer to store responses from the isolated web application for each fragment in a cache.

15. The apparatus of claim 14 wherein the program further directs the surrogate computer to extract a context for executing a fragment from the cached response of a previously executed fragment.

16. The apparatus of claim 15, wherein the program further directs the surrogate computer to add metadata protocol header to the fragment with the context before dispatching the fragment.

17. The apparatus of claim 12, wherein the program further directs the surrogate computer to dispatch the fragments in a particular sequence.
